(19) United States
(12) Patent Application Publication
(10) Pub. No.: US 2017/0252803 A1
(43) Pub. Date: Sep. 7, 2017

(54) METHOD FOR MANUFACTURING COMPONENTS OF A SWIVEL MOTOR FOR A STEERING SYSTEM

(71) Applicant: Robert Bosch Automotive Steering GmbH, Schwäbish Gmünd (DE)

(72) Inventors: Markus Rief, Ellwangen (DE); Martin Maier, Schwäbisch Gmünd (DE); Walter Kogel, Abtsgmünd (DE)

(21) Appl. No.: 15/507,010

(22) PCT Filed: Aug. 14, 2015
(86) PCT No.: PCT/EP2015/068724

§ 371 Date: Feb. 27, 2017

(30) Foreign Application Priority Data
Aug. 28, 2014 (DE) 10 2014 112 377.8

(51) Int. Cl. B22F 3/10; B22F 3/16

(52) U.S. Cl. CPC B22F 3/1017; B22F 3/16; B62D 5/14

(57) ABSTRACT

The description relates to a powder-metallurgical method for manufacturing components of a swivel motor for a vehicle steering system, said method involving the steps of: pressing 2, 3, 4, 5, 6 or any number of wing elements, assembling the wing elements, and sintering the assembled wing elements, and/or pressing 2, 3, 4, 5, 6 or any number of housing elements, assembling the housing elements, and sintering the housing elements.

### BACKGROUND OF THE INVENTION

The present invention relates to a powder-metallurigical method and a steering system for a vehicle comprising a swivel motor for power steering assistance.

Ball-and-nut power steering systems are known in the prior art for steering gears for high steering axle loads.

### SUMMARY OF THE INVENTION

Ball-and-nut power steering systems have a complex construction. The manufacture of a ball-and-nut steering system involves high costs also for this reason.

It is therefore an aim of the invention to provide a steering gear for high steering axle loads which is particularly characterized by a simple and therefore cost effective manufacturing process.

As a first embodiment of the invention, a powder-metallurigical method for manufacturing components of a swivel motor for a steering system of a vehicle is provided, said method involving the steps: pressing 2, 3, 4, 5, 6 or any number of wing elements, assembling the wing elements and sintering the wing elements and/or pressing 2, 3, 4, 5, 6 or any number of housing kelements, assembling the housing elements and sintering the housing elements.

By means of the design of the swivel motor according to the invention out of a plurality of individual parts, in particular with identical types for multiple use in a swivel motor, pressing processes involving large elements can be avoided. Instead, a multiplicity of small elements are pressed, assembled and formed to a unit by sintering. As a result, a powder-metallurgical method is made possible even for large swivel motors. Moreover, an arbitrary scalability of the swivel motors according to the invention results. By means of the arbitrarily large selection of the pressure chambers of the swivel motor, swivel motors can further be produced for high torques without the pressure chambers in question having to be designed for high pressures.

A further substantial advantage of the method according to the invention is that long, narrow grooves of the wing elements and/or the housing elements, in contrast to the conventional manufacturing method, are possible without any large problems using the powder-metallurigical process. In the case of a conventional machining method, delicate tools are required which result in short service lives and low feed rates. Seals are inserted into the grooves, which in turn are necessary in order to seal off the individual chambers of the swivel motor from one another.

As a second embodiment of the invention, a steering system for a vehicle having a swivel motor for power steering assistance is provided, wherein the swivel motor is manufactured according to a method of the invention.

According to one exemplary embodiment of the invention, a method is provided, wherein the wing elements and/or the housing elements are designed at least virtually identically.

By means of the identical design of the wing elements and/or the housing elements, identical pressing tools can be used. In addition, the wing elements and/or housing elements can be manufactured in the same press, whereby a cost-effective manufacture is ensured.

In a further embodiment according to the invention, a method is provided, wherein the pressing of the wing elements and/or the pressing of the housing elements results by means of the shaping process: “press vertically”.

According to a further exemplary embodiment of the present invention, a method is provided, said method further involving the steps: fitting a shaft into the sintered wing elements, assembling the sintered wing elements comprising the shaft and the sintered housing elements to a swivel motor.

It can be considered a concept of the invention to construct a swivel motor as a steering gear for high steering axle loads, said swivel motor consisting of a plurality of powder-metallurgical pressed components (green parts) which are sintered to a unit. The components can, for example, be wing elements and/or housing elements. By means of a sequential succession or respectively stacking of a plurality of wing elements or a plurality of housing elements, swivel motors can be manufactured for arbitrarily high torques. Long, narrow grooves can be advantageously achieved by the method according to the invention, whereby advantageous embodiments of a swivel motor comprising long wing elements are easily made possible in a production technical manner. The seals necessary for sealing the chambers can be inserted in these grooves.

The individual features can, of course, also be combined with one another, whereby advantageous effects can also arise in part which go beyond the sum of the individual effects.

### BRIEF DESCRIPTION OF THE DRAWINGS

Further details and advantages of the invention are clearly described with the aid of the exemplary embodiments depicted in the drawings. In the drawings:

FIG. 1 shows a ball-and-nut power-steering gear according to the prior art;

FIG. 2 shows a depiction of the swivel motor principle;

FIG. 3 shows a wing element 2 that is disposed on a shaft 3;

FIG. 4 shows a housing 1 for receiving and mounting the wing element 2 with shaft 2 of FIG. 3;

FIG. 5 shows the shaft 3, which can be conventionally manufactured by machining methods, in particular turning;

FIG. 6 shows the wing element/wing segment 2, which can be disposed on the shaft 3;

FIG. 7 shows individual wing elements/wing segments 2, which can be produced by a powder-metallurgical pressing process;

FIG. 8 shows the individual wing elements 2 in an assembled, sintered state;

FIG. 9 shows individual housing elements/housing segments 5, which can be made into green bodies by means of pressing;

FIG. 10 shows the individual housing elements/housing segments 5 in an assembled, sintered state;

FIG. 11 shows a wing element 2 comprising two different wings having different centroids of an area 10, 11;

FIG. 12 shows the wing element 2 with the centroid of the area 11 of the wing.

### DETAILED DESCRIPTION

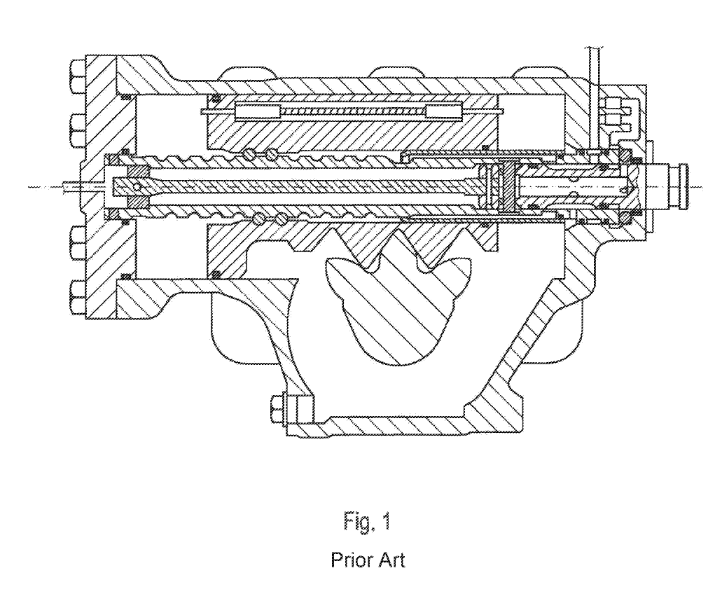

FIG. 1 shows a steering gear according to the prior art for high steering axle loads. Such ball-and-nut power steering systems are characterized by a robust design and a compact construction.

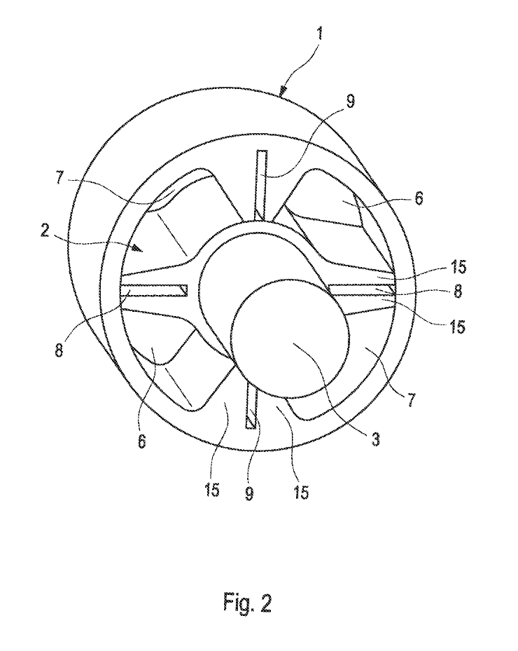

FIG. 2 shows a swivel motor for generating a torque on the shaft 3. A force is exerted on the respective wing elements 2 by introducing a fluid into the chambers 6 or 7, whereby a torque is generated which can be tapped at the shaft 3. A requirement for a flawless function is a sealing of the individual chambers 6, 7. To this end, grooves 8 are formed on the wing elements 2 and grooves 9 on the housing 1, which are disposed between web regions. The grooves 8, 9 are provided for receiving sealing frames for sealing the chambers 6, 7.

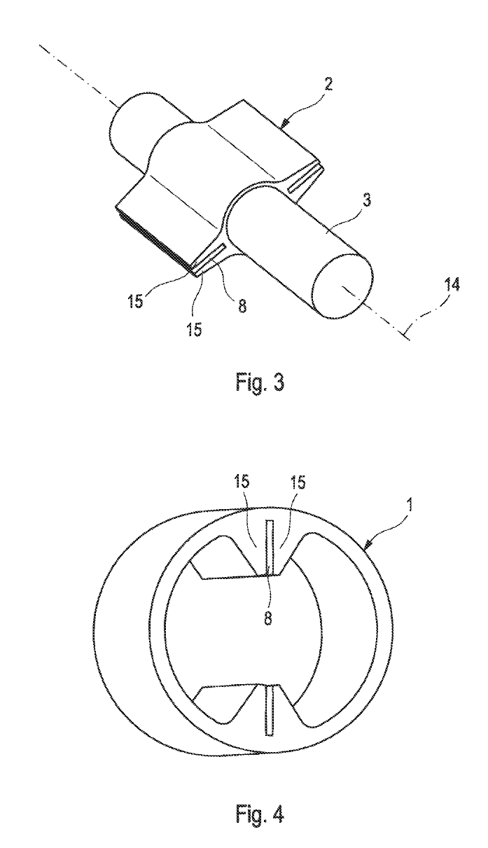

FIG. 3 shows a wing element 2 that is disposed on a shaft 3. The wing element 2 is used to generate a torque on the shaft 3. Grooves 8 are disposed between web regions 15, wherein the grooves 8 are suited to receiving sealing material.

FIG. 4 shows a housing 1 for receiving and mounting the wing shaft 2 together with the shaft 3 of FIG. 3. Grooves 9 between web regions 15 are used for receiving sealing material.

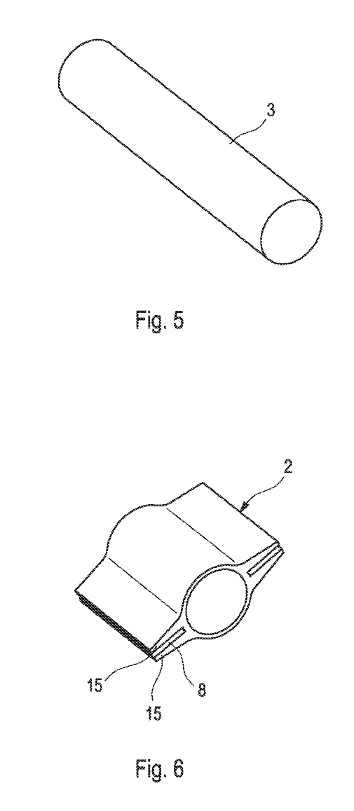

FIG. 5 shows a shaft 3 which is produced by a machining method, therefore conventionally.

FIG. 6 shows the wing element 2 that can be disposed on the shaft 3.

FIG. 7 shows a plurality of wing elements 2, which can be made into green bodies by means of pressing. Small wing elements 2 are advantageously pressed instead of one large individual element. As a result, a high degree of homogeneity can be ensured.

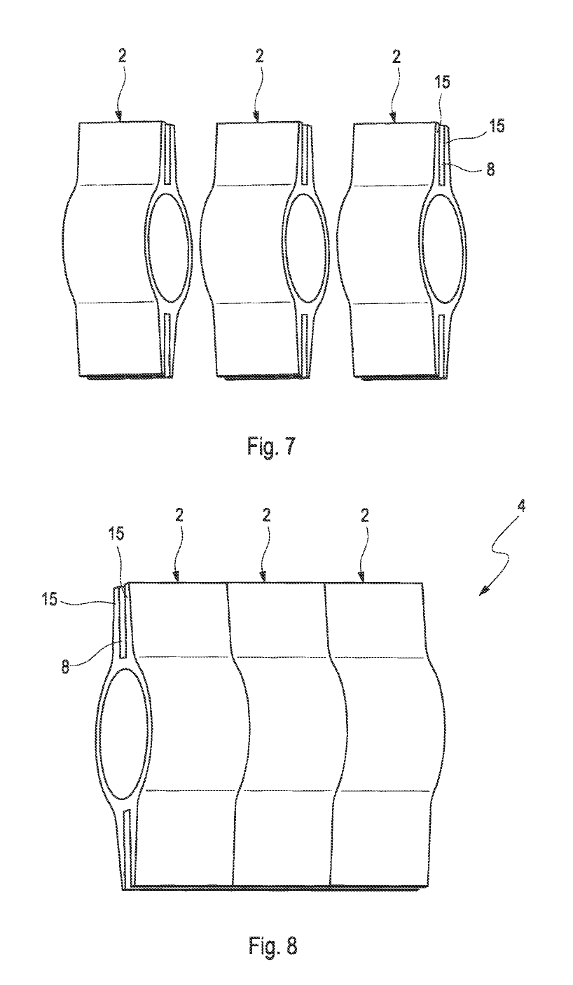

FIG. 8 shows wing segments 2 according to FIG. 7 in an assembled and sintered state. Instead of 3 wing segments 2, any number of wing segments 2 can be sintered together, whereby an arbitrary scalability of the swivel motor in question results.

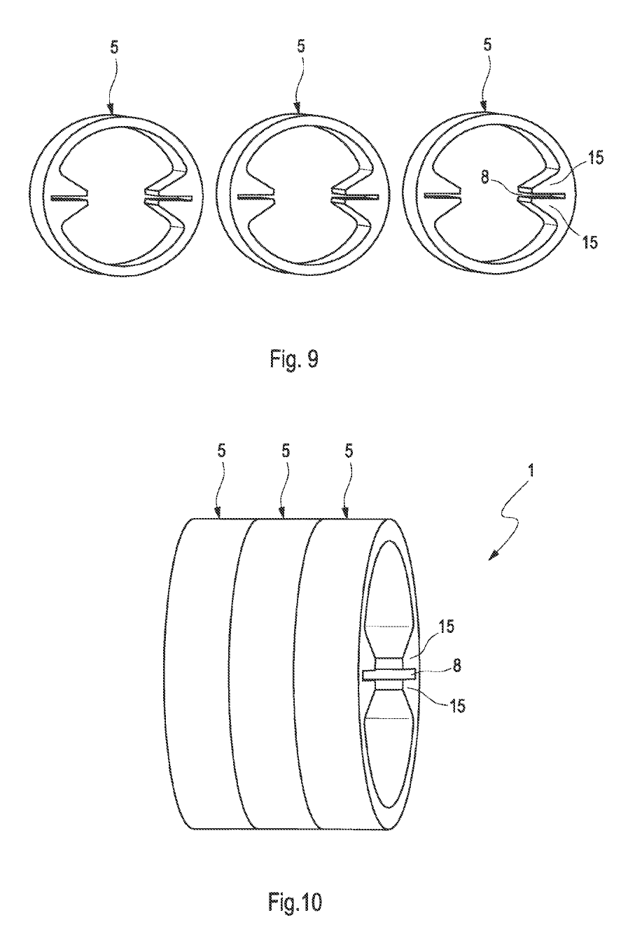

FIG. 9 shows individual housing segments 5, which result in green bodies after a pressing operation. By dividing the housing 1 into individual housing segments 5 that can be assembled, a large individual part does not have to be produced in a powder-metallurgical manner. As a result, a high degree of homogeneity of the pressed housing 1 in question can be ensured

FIG. 10 shows the housing 1 that results from sintering the housing segments 5 of FIG. 9 together. Instead of 3 housing segments 5, any number 2, 3, 4, 5, 6, 7, 8, 9 of housing segments 5 can be sintered together. As a result, an arbitrary scalability of the corresponding swivel motor can be achieved.

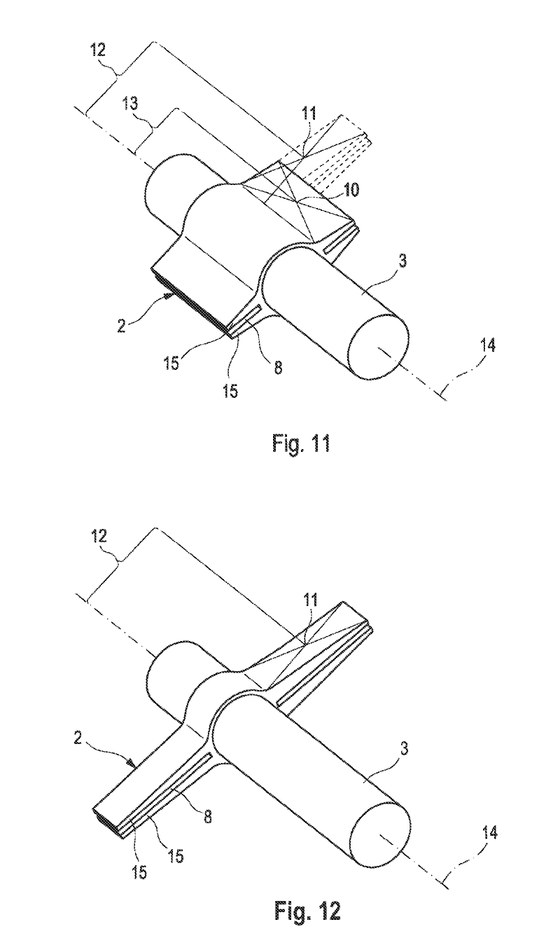

FIG. 11 shows a wing element with two differently configured wings, which have different centroids of an area for a fluid that is pressed into a corresponding chamber of the swivel motor. The centroid of the area 11 is significantly further removed from the middle axis 14 in comparison to the centroid of the area 10. That results in a higher torque in the case of otherwise equal geometric dimensions and pressures of the fluid in the chambers of the swivel motor. There is, however, the need to configure very deep, narrow grooves 8 in the case of a wing element having a centroid of the area 11. When producing the grooves 8 in a conventional manner, a delicate tool is required, whereby short service lives and feed rates result. By means of the inventive use of as powder-metallurgical method, such difficulties can be circumvented. Analogous advantages result in the case of housing elements having corresponding long, narrow grooves.

FIG. 12 shows an advantageous wing element 2 having deep grooves 8, which are disposed between the web regions 15. By pressing and sintering of individual wing elements 2, correspondingly required components for swivel motors can be obtained, which have a centroid of an area that is advantageously spaced apart from the middle axis 14 at a large distance.

It should be noted that the terms “comprise” or “involve the” do not exclude further elements or method steps. The term “one” likewise does not exclude a plurality of elements and steps.

The reference signs used only serve to increase the understandability and should in no way be seen as limiting, wherein the protective area of the invention is reflected by the claims.

### LIST OF THE REFERENCE SIGNS

1 housing assembled from a plurality of housing elements

2 wing element/wing segment

3 shaft

4 wing assembled from a plurality of wing segments

5 housing element/housing segment

6 chamber

7 chamber

8 groove for sealing frame on the wing element

9 groove for sealing frame on the housing element

10 centroid of the area

11 centroid of the area

12 spacing

13 spacing

14 middle axis

15 web region

1. A powder-metallurgical method for manufacturing components of a swivel motor for a vehicle steering system, said method comprising the steps of:
pressing 2, 3, 4, 5, 6 or any number of wing elements (2),
assembling the wing elements (2), and
sintering the wing elements (2).

2. A method according to claim 1, wherein the wing elements (2) are at least nearly identical.

3. The method according to claim 1, wherein the pressing of the wing elements (2) takes place by means of the shaping process “vertically pressing”.

4. The method according to claim 1, further comprising the steps of:
placing a shaft (3) into the sintered wing elements (2), assembling the sintered wing elements (2) with the shaft (3).

5. (canceled)

6. The method according to claim 1, further comprising the steps of:
pressing 2, 3, 4, 5, 6 of any number of housing elements (5),
assembling the housing elements (5), and
sintering the housing elements (5).

7. The method according to claim 6, wherein the housing elements (5) are at least nearly identical.

8. The method according to claim 6, wherein the pressing of the housing elements (5) takes place by means of the shaping process “vertically pressing”.

9. The method according to claim 6, further comprising the steps of:
placing a shaft (3) into the sintered wing elements (2),
assembling the sintered wing elements (2) with the shaft (3) and the sintered housing elements (5) to a swivel motor.

10. A powder-metallurgical method for manufacturing components of a swivel motor for a vehicle steering system, said method comprising the steps of:
pressing 2, 3, 4, 5, 6 of any number of housing elements (5),
assembling the housing elements (5), and
sintering the housing elements (5).

11. A method according to claim 10, wherein the housing elements (5) are at least nearly identical.

12. The method according to claim 10, wherein the pressing of the housing elements (5) takes place by means of the shaping process “vertically pressing”.

13. The method according to claim 10, further comprising the step of:
assembling the sintered housing elements (5) to a swivel motor.
